(19) United States
(12) Patent Application Publication
(10) Pub. No.: US 2024/0232534 A9
(43) Pub. Date: Jul. 11, 2024

(54) WORD SELECTION SUPPORT DEVICE, WORD SELECTION SUPPORT METHOD, AND PROGRAM

(71) Applicant: NIPPON TELEGRAPH AND TELEPHONE CORPORATION, Tokyo (JP)

(72) Inventors: Shota ORIHASHI, Tokyo (JP); Masato SAWADA, Tokyo (JP)

(73) Assignee: NIPPON TELEGRAPH AND TELEPHONE CORPORATION, Tokyo (JP)

(21) Appl. No.: 18/279,584

(22) PCT Filed: Mar. 1, 2021
(86) PCT No.: PCT/JP2021/007623

§ 371 Date: Aug. 30, 2023

(51) Int. Cl. G06F 40/295; G06F 40/157

(52) U.S. Cl. CPC G06F 40/295; G06F 40/157

(57) ABSTRACT

A word selection support device according to the present disclosure includes processing circuitry configured to derive, for each extracted unknown word that is a term that is extracted from a target corpus and is not registered in dictionary data, statistical information regarding the extracted unknown word in a plurality of corpuses including the target corpus, and calculate appropriateness as a registered unknown word possibility that is a possibility of an unknown word to be registered in the dictionary data for each of the extracted unknown word on the basis of the statistical information.

### TECHNICAL FIELD

The present disclosure relates to a word selection support device, a word selection support method, and a program.

### BACKGROUND ART

In recent years, for the purpose of improving the service quality in a contact center, there has been proposed a system that performs voice recognition on call content in real time and automatically presents appropriate information to an operator who is receiving a call by making full use of natural language processing technology.

For example, Non Patent Literature 1 discloses a technique of presenting questions assumed in advance and answers to the questions (FAQ) to an operator in conversation between the operator and a customer. In this technology, conversation between an operator and a customer is subjected to voice recognition, and is converted into a semantic utterance text by “utterance end determination” for determining whether the speaker has finished speaking. Next, “service scene estimation” for estimating in which service scene in conversation the utterance corresponding to the utterance text is, such as greetings by the operator, confirmation of a requirement of the customer, response to the requirement, or closing of the conversation, is performed. The conversation is structured by the “service scene estimation”. From a result of the “service scene estimation”, “FAQ retrieval utterance determination” for extracting utterance including a requirement of the customer or utterance in which the operator confirms a requirement of the customer is performed. Retrieval using a retrieval query based on the utterance extracted by the “FAQ retrieval utterance determination” is performed on a database of the FAQ prepared in advance, and a retrieval result is presented to the operator.

In such a configuration for structuring conversation or performing natural language processing such as FAQ retrieval, preparing a dictionary for converting an input character string into a numerical string that can be handled by a computer in consideration of a group of words is essential. Here, for words that cannot be processed by a morphological analysis dictionary covering standard words, for example, a dictionary covering technical terms for each domain such as an industry (for example, communication industry and insurance industry) handled by a contact center is required. Regarding preparation of such a dictionary, a method of extracting words that cannot be processed by a standard morphological analysis dictionary from a corpus created by collecting a large number of texts of a target domain has been proposed (Non Patent Literature 2).

### CITATION LIST

### Non Patent Literature

Non Patent Literature 1: Takaaki Hasegawa, Yuichiro Sekiguchi, Setsuo Yamada, Masafumi Tamoto, “Automatic Recognition Support System That Supports Operator Service,” NTT Technical Journal, vol. 31, no. 7, pp. 16-19, July 2019.
Non Patent Literature 2: S. Mori and M. Nagao, “Word Extraction from Corpora and Its Part-of-Speech Estimation Using Distributional Analysis,” The 16th International Conference on Computational Linguistics (COLING), 1996.

### SUMMARY OF INVENTION

### Technical Problem

According to the above method, unknown words not included in the standard morphological analysis dictionary can be extracted from the corpus obtained by collecting. However, for example, in a case where a dictionary is created for an application such as FAQ retrieval, if all the extracted unknown words are added to the dictionary, a large number of unknown words irrelevant to an FAQ desired to be actually retrieved are registered in the dictionary, which may cause deterioration in retrieval accuracy. Therefore, words to be registered in the dictionary (hereinafter, referred to as “registered unknown words”) from the words extracted as unknown words (hereinafter, referred to as “extracted unknown words”).

FIG. 9 is a diagram schematically illustrating selection work of registered unknown words using a conventional method. In a case of using the conventional method, extraction of extracted unknown words 92 from a target corpus 91 can be performed by a method described in Non Patent Literature 2 or the like. However, selection of registered unknown words 93 from the extracted unknown words 92 needs to be performed by manual verification in order to exclude, for example, synonyms, non-meaningful character strings, and the like. Performing such manual work for each target domain of a contact center has been difficult due to enormous work cost. Furthermore, know-how regarding selection of registered unknown words that contribute to improvement in accuracy of FAQ retrieval is required for the selection work, and thus analysis based on tacit knowledge of an expert is required, and there is a possibility that overlooking of useful words may occur depending on the skill of a worker.

An object of the present disclosure is to provide a word selection support device, a word selection support method, and a program that enable efficient selection of useful unknown words to be registered in a dictionary in an application target domain (registered unknown words) from a word group mechanically extracted as unknown words (extracted unknown words).

### Solution to Problem

In order to solve the above issues, a word selection support device according to the present disclosure includes a first derivation unit that derives, for each extracted unknown word that is a term that is extracted from a target corpus and is not registered in dictionary data, first statistical information that is statistical information regarding the extracted unknown word in a plurality of corpuses including the target corpus, and a calculation unit that calculates appropriateness as a registered unknown word possibility that is a possibility of an unknown word to be registered in the dictionary data for each of the extracted unknown word on the basis of the first statistical information.

Furthermore, a word selection support device according to the present disclosure includes a first derivation unit that derives, for each extracted unknown word that is a term that is extracted from a target corpus and is not registered in dictionary data, first statistical information that is statistical information regarding the extracted unknown word in a plurality of corpuses including the target corpus, and a generation unit that generates a presentation screen of a registered unknown word possibility that is a possibility of an unknown word to be registered in the dictionary data from the extracted unknown word on the basis of the first statistical information.

Furthermore, a word selection support method according to the present disclosure includes steps performed by a processor of a word selection support device, the steps including a step of deriving, for each extracted unknown word that is a term that is extracted from a target corpus and is not registered in dictionary data, statistical information regarding the extracted unknown word in a plurality of corpuses including the target corpus, and a step of calculating appropriateness as a registered unknown word possibility that is a possibility of an unknown word to be registered in the dictionary data from the extracted unknown word on the basis of the statistical information.

Furthermore, a program according to the present disclosure causes a computer to function as the above word selection support device.

### Advantageous Effects of Invention

According to one embodiment of the present disclosure, useful unknown words to be registered in a dictionary in an application target domain can be efficiently selected from a word group mechanically extracted as unknown words.

### BRIEF DESCRIPTION OF DRAWINGS

FIG. 1 is a block diagram illustrating a schematic configuration of a computer that functions as a word selection support device according to one embodiment of the present disclosure.

FIG. 2 is a diagram schematically illustrating selection work of registered unknown words using the word selection support device according to the one embodiment of the present disclosure.

FIG. 3 is a block diagram illustrating a functional configuration example of a support system using the word selection support device according to the one embodiment of the present disclosure.

FIG. 4 is a flowchart illustrating an example of operation of the word selection support device according to the one embodiment of the present disclosure.

FIG. 5 is a block diagram illustrating a functional configuration example of a support system using a word selection support device according to one embodiment of the present disclosure.

FIG. 6 is a flowchart illustrating an example of operation of the word selection support device according to the one embodiment of the present disclosure.

FIG. 7 is a block diagram illustrating a functional configuration example of a support system using a word selection support device according to one embodiment of the present disclosure.

FIG. 8 is a flowchart illustrating an example of operation of the word selection support device according to the one embodiment of the present disclosure.

FIG. 9 is a diagram schematically illustrating selection work of registered unknown words using a conventional method.

### DESCRIPTION OF EMBODIMENTS

Hereinafter, one embodiment of the present disclosure will be described with reference to the drawings. In the drawings, the same or corresponding parts will be denoted by the same reference signs. In description of the embodiments, description of the same or corresponding parts will be omitted or simplified as appropriate.

### First Embodiment

A word selection support device 10 according to the present embodiment supports selection work of registered unknown words by mechanically selecting words that are possibilities for the registered unknown words (hereinafter, referred to as “registered unknown word possibilities”) from extracted unknown words when performing work of registering unknown words in dictionary data. Specifically, the word selection support device 10 selects registered unknown word possibilities on the basis of statistical information regarding the appearances of extracted unknown words in a plurality of corpuses. Such corpuses may include a corpus from which extracted unknown words are extracted (hereinafter, referred to as a “target corpus”), a corpus including document data including general words (hereinafter, referred to as a “general corpus”), and a corpus including document data including many technical terms close to the target corpus (hereinafter, referred to as a “specialized corpus”). The word selection support device 10 according to the present embodiment mechanically extracts possibilities of useful registered unknown words to be registered in a dictionary in an application target domain from a word group mechanically extracted as extracted unknown words, and thus registered unknown words can be efficiently selected.

In each embodiment of the present disclosure, an example in which registered unknown words to be registered in a dictionary are selected from extracted unknown words extracted from a corpus by a method such as Non Patent Literature 2 for a dictionary used in an FAQ retrieval application in a contact center such as Non Patent Literature 1 will be described. However, an application target of each embodiment of the present disclosure is not limited to preparation of a dictionary used for FAQ retrieval for a contact center and selection of registered unknown words from extracted unknown words extracted from a corpus. That is, each embodiment of the present disclosure can be applied to any dictionary used for natural language processing. Furthermore, each embodiment of the present disclosure can be applied to any selection work of extracting words to be actually registered from a possibility group of words to be registered in a dictionary.

(Hardware Configuration of Word Selection Support Device)

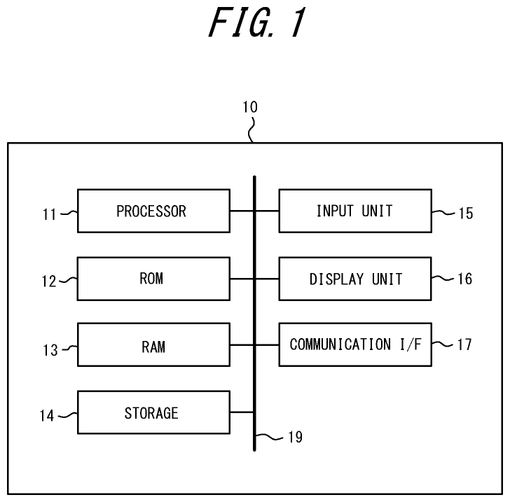

FIG. 1 is a block diagram illustrating a hardware configuration in a case where a word selection support device 10 according to one embodiment of the present disclosure is a computer capable of executing a program command. Here, the computer may be a general-purpose computer, a dedicated computer, a workstation, a personal computer (PC), an electronic note pad, or the like. The program command may be a program code, code segment, or the like for executing a necessary task.

As illustrated in FIG. 1, the word selection support device 10 includes a processor 11, a read only memory (ROM) 12, a random access memory (RAM) 13, a storage 14, an input unit 15, a display unit 16, and a communication interface (I/F) 17. The configurations are communicably connected to each other via a bus 19. Specifically, the processor 11 is a central processing unit (CPU), a micro processing unit (MPU), a graphics processing unit (GPU), a digital signal processor (DSP), a system on a chip (SoC), or the like and may be configured by the same or different types of plurality of processors.

The processor 11 executes control of each configuration and various types of arithmetic processing. That is, the processor 11 reads a program from the ROM 12 or the storage 14 and executes the program by using the RAM 13 as a working area. The processor 11 performs control of each of the foregoing configurations and various types of arithmetic processing according to a program stored in the ROM 12 or the storage 14. In the present embodiment, a program according to the present disclosure is stored in the ROM 12 or the storage 14.

The program may be provided in a form in which the program is stored in a non-transitory storage medium, such as a compact disk read only memory (CD-ROM), a digital versatile disk read only memory (DVD-ROM), or a universal serial bus (USB) memory. The program may be downloaded from an external device via a network.

The ROM 12 stores various programs and various types of data. The RAM 13 as a work area temporarily stores programs or data. The storage 14 includes a hard disk drive (HDD) or a solid state drive (SSD) and stores various programs including an operating system and various types of data.

The input unit 15 includes a pointing device, a keyboard, and the like and is used to perform various inputs.

The display unit 16 is, for example, a liquid crystal display, and displays various types of information. A touch panel system may be adopted so that the display unit 16 can function as the input unit 15.

The communication interface 17 is an interface for communicating with another device such as an external device (not illustrated), and for example, a standard such as Ethernet (registered trademark), fiber distributed data interface (FDDI), and Wi-Fi (registered trademark) is used.

(Outline of Work Using Word Selection Support Device)

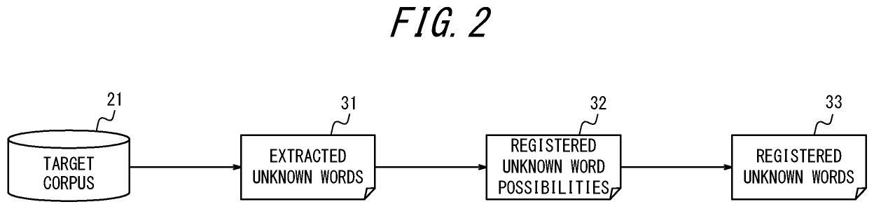

Next, an outline of work of selecting registered unknown words using the word selection support device 10 will be described with reference to FIG. 2. FIG. 2 is a diagram schematically illustrating selection work of registered unknown words using the word selection support device 10 according to the one embodiment of the present disclosure.

In FIG. 2, a target corpus 21 is a corpus that is a target from which terms not registered in dictionary data (unknown words) are extracted. The corpus is a set of pieces of document data such as text data. In the present embodiment, first, extracted unknown words 31 are mechanically extracted from the target corpus 21 using a method disclosed in Non Patent Literature 2 or the like. Next, registered unknown word possibilities 32 as possibilities for registered unknown words are mechanically extracted from the extracted unknown words 31 and presented to a worker. Then, the worker selects registered unknown words 33 to be registered in the dictionary data from the registered unknown word possibilities 32, and registers the registered unknown words 33 in the dictionary data. Note that, in the present embodiment, the worker confirms the registered unknown word possibilities 32 and decides the registered unknown words 33 by excluding words that should not be registered in the dictionary data, but the registered unknown word possibilities 32 may be set as the registered unknown words 33 as they are.

(Functional Configuration of Word Selection Support Device)

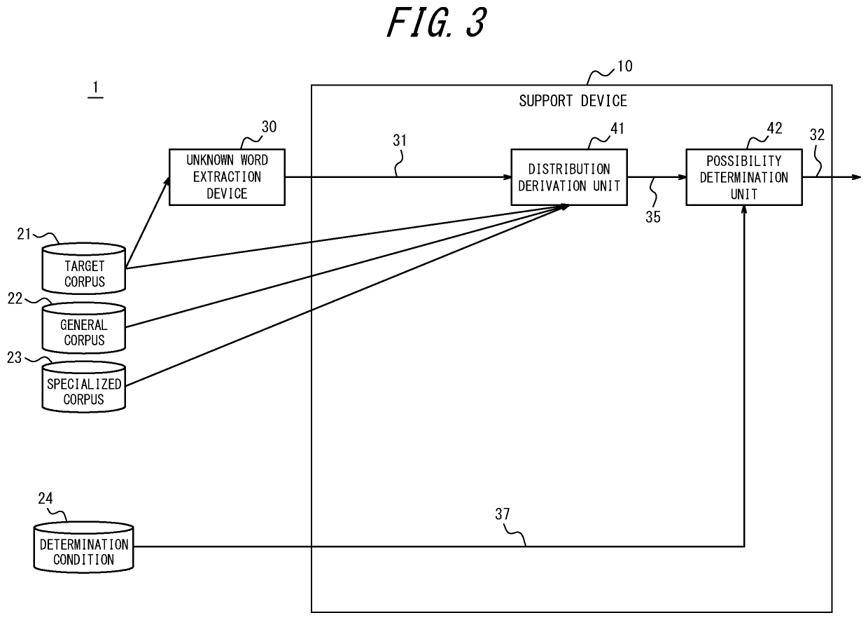

Next, a support system 1 using the word selection support device 10 of dictionary registration work for performing the above processing will be described. FIG. 3 is a block diagram illustrating a functional configuration example of the support system 1 using the word selection support device 10 according to the one embodiment of the present disclosure.

The support system 1 includes the word selection support device 10, the target corpus 21, a general corpus 22, a specialized corpus 23, a determination condition 24, and an unknown word extraction device 30. The word selection support device 10 includes a distribution derivation unit 41 and a possibility determination unit 42. The unknown word extraction device 30 and the word selection support device 10 may be configured by dedicated hardware such as an application specific integrated circuit (ASIC) or a field-programmable gate array (FPGA), or may be configured by one or more processors 11 as described above.

As described above, the target corpus 21 is a corpus that is a target from which terms not registered in dictionary data (unknown words) are extracted. In the present embodiment, an example in which the target corpus 21 is a set of pieces of document data related to a specific field such as insurance will be described.

As described above, the general corpus 22 is a corpus including document data in a general field. The general corpus 22 is formed by collecting document data widely from a plurality of domains or collecting document data from a specific domain assumed to have less overlap with a domain of the target corpus 21. For example, in a case where the domain of the target corpus 21 is insurance, the general corpus 22 may be a corpus formed by collecting document data from an unspecified number of domains. Alternatively, the general corpus 22 may be a corpus formed by collecting document data from, for example, an electric power domain or the like that is assumed to have less overlap with the insurance domain.

Note that, in a case where the general corpus 22 is formed by widely collecting document data from a plurality of domains, the general corpus 22 may include some or all of elements of the target corpus 21 on condition that the number of elements that are not of the target corpus 21 is sufficiently larger than the number of the elements of the target corpus 21. Furthermore, the general corpus 22 may include some or all of elements of the specialized corpus 23 on condition that the number of elements that are not of the specialized corpus 23 is sufficiently larger than the number of the elements of the specialized corpus 23.

Furthermore, in a case where the general corpus 22 is formed by collecting document data from a specific domain assumed to have less overlap with the domain of the target corpus 21, the general corpus 22 may include some of the elements of the target corpus 21 on condition that the number of elements that are not of the target corpus 21 is sufficiently larger than the number of the elements of the target corpus 21. Furthermore, the general corpus 22 may include some of the elements of the specialized corpus 23 on condition that the number of elements that are not of the specialized corpus 23 is sufficiently larger than the number of the elements of the specialized corpus 23.

As described above, the specialized corpus 23 is a corpus including document data of a specialized field related to the target corpus 21. The specialized corpus 23 is formed by collecting document data from a domain including a target domain or a domain included in the target domain. For example, in a case where the domain of the target corpus 21 is insurance, the specialized corpus 23 may be a corpus obtained by collection from a non-life insurance domain or a life insurance domain. Note that the specialized corpus 23 may include some or all of the elements of the target corpus 21 on condition that the number of elements that are not of the target corpus 21 is sufficiently larger than the number of the elements of the target corpus 21.

The determination condition 24 includes at least one piece of condition information 37 indicating a condition when the word selection support device 10 determines registered unknown word possibilities 32 on the basis of statistical information 35 regarding the appearances of extracted unknown words 31 in the target corpus 21, the general corpus 22, and the specialized corpus 23. As will be described below, condition information 37 indicating a condition according to the application or purpose is used in the word selection support device 10. A specific example of the determination condition 24 will be described below.

The unknown word extraction device 30 is a device that extracts at least one unknown word (extracted unknown word 31) that is a term not registered in the dictionary data from the target corpus 21. The unknown word extraction device 30 extracts extracted unknown words 31 from the target corpus 21 using, for example, a conventional method disclosed in Non Patent Literature 2 or the like.

The distribution derivation unit 41 of the word selection support device 10 acquires at least one extracted unknown word 31 that is a term extracted from the target corpus 21 by the unknown word extraction device 30 and not registered in the dictionary data. Then, the distribution derivation unit 41 derives statistical information 35 regarding the appearances of the extracted unknown words 31 in a plurality of corpuses including the target corpus 21 (for example, general corpus 22 and specialized corpus 23) for each of the extracted unknown words 31.

The possibility determination unit 42 of the word selection support device 10 receives the statistical information 35 and the condition information 37 in each of the corpuses 21 to 23 of the extracted unknown words 31 as inputs, determines registered unknown word possibilities 32, and outputs the registered unknown word possibilities 32. The possibility determination unit 42 functions as a calculation unit that calculates the appropriateness as a registered unknown word possibility that is a possibility for an unknown word to be registered in the dictionary data for each of the extracted unknown words on the basis of the statistical information 35 in each of the corpuses 21 to 23 of the extracted unknown words 31. Furthermore, the possibility determination unit 42 also functions as a generation unit that generates a presentation screen of the registered unknown word possibilities from the extracted unknown words on the basis of the statistical information 35 in each of the corpuses 21 to 23 of the extracted unknown words 31.

Note that FIG. 3 illustrates an example of a case where the target corpus 21, the general corpus 22, the specialized corpus 23, the determination condition 24, and the unknown word extraction device 30 exist outside the word selection support device 10 for convenience, but the support system is not limited to such a configuration. For example, all the configurations of the support system 1 may be implemented by the same computer. Furthermore, the word selection support device 10 may include at least a part of the target corpus 21, the general corpus 22, the specialized corpus 23, the determination condition 24, and the unknown word extraction device 30.

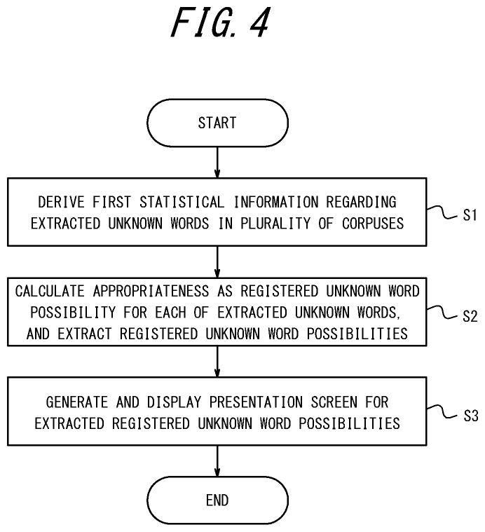

Processing of the word selection support device 10 in the present embodiment will be described. FIG. 4 is a flowchart illustrating an example of operation of the word selection support device 10 according to a first embodiment. The operation of the word selection support device 10 described with reference to FIG. 4 corresponds to a word selection support method according to the present embodiment. A program for causing a computer to execute the word selection support method according to the present embodiment includes steps illustrated in FIG. 4.

In step S1, the distribution derivation unit 41 (processor 11) derives statistical information 35 regarding the appearances of extracted unknown words 31 in each of corpuses using the extracted unknown words 31, a target corpus 21 that is the extraction source of the extracted unknown words 31, a general corpus 22, and a specialized corpus 23 as inputs. Specifically, when the extracted unknown words 31 are given, the distribution derivation unit 41 calculates the numbers of the appearances of the extracted unknown words 31 in each of the corpuses, and outputs the frequency distribution and the number of the appearances of each of the extracted unknown words 31 as the statistical information 35.

In step S2, the possibility determination unit 42 (processor 11) calculates the appropriateness as a registered unknown word possibility 32 that is a possibility for an unknown word to be registered in dictionary data for each of the extracted unknown words 31 on the basis of a determination condition indicated by the condition information 37 using the statistical information 35 in each of the corpuses of the extracted unknown words 31 and the condition information 37 from the determination condition 24 as inputs. The possibility determination unit 42 (processor 11) extracts registered unknown word possibilities 32 on the basis of the calculation result of the appropriateness of each of the extracted unknown words 31.

Here, the determination condition is an extraction condition based on an appearance frequency in each of the corpuses. The determination condition may be, for example, any combination of the following conditions.
A condition using an absolute value of the number of appearances, such as that the number of appearances of an extracted unknown word 31 in each of the corpuses is N or more.
A condition that relatively identifies a position in the appearance frequency distribution, such as that the number of appearances of an extracted unknown word 31 in each of the corpuses is in the top N % of the entire extracted unknown words.

Furthermore, the appropriateness is a numerical value indicating a degree to which an extracted unknown word 31 is appropriate as a registered unknown word possibility 32. Hereinafter, an example of a case where the appropriateness is calculated by binary values of an appropriate case and an inappropriate case (for example, 0/1) will be described. That is, an example in which the appropriateness of extracted unknown words 31 satisfying the above determination conditions is calculated as “1”, and the appropriateness of other extracted unknown words 31 is calculated as “0” will be described. However, a method of calculating the appropriateness is not limited thereto, and for example, the possibility determination unit 42 may calculate the degree of appropriateness on the basis of an appearance frequency of an extracted unknown word 31 in each of the corpuses as a score that is not limited to binary values (for example, any value of 0 to 1). Specifically, for example, the possibility determination unit 42 may calculate a larger value as the appropriateness for an extracted unknown word satisfying more determination conditions, and may calculate a smaller value as the appropriateness for an extracted unknown word satisfying fewer determination conditions. In the present embodiment, the possibility determination unit 42 extracts extracted unknown words that exceed a predetermined threshold as registered unknown word possibilities 32.

As described above, in the present embodiment, the condition information 37 is determined in advance in the determination condition 24. Therefore, the processor 11 may give a plurality of combinations including a condition in which the precision is prioritized, a condition in which the recall is prioritized, and the like and output a plurality of combinations of registered unknown word possibilities 32. Here, the recall and the precision are evaluation indexes of a binary classification problem in which an unknown word to be registered in the dictionary data manually selected from at least one extracted unknown word 31 is set as correct data (reference).

The binary classification problem is a problem of determining positive or false for a certain proposition (e.g. should the extracted unknown word be registered in the dictionary data?). There are four patterns of results (predictions) derived by a determiner and actual results regarding the binary classification, i.e., true positive (TP), true negative (TN), false positive (FP), and false negative (FN). TP indicates a case where a prediction by the determiner is positive (e.g. it should be registered in the dictionary data) and the prediction correctly indicates an actual result (true), that is, the actual result is also positive. TN indicates a case where a prediction by the determiner is negative (e.g. it should not be registered in the dictionary data) and the prediction correctly indicates an actual result (true), that is, the actual result is also negative. FP indicates a case where a prediction by the determiner is positive and the prediction does not correctly indicate an actual result (false), that is, the actual result is negative. FN indicates a case where a prediction by the determiner is negative and the prediction does not correctly indicate an actual result (false), that is, the actual result is positive.

The recall is a ratio of data that can be correctly determined to be positive among data that should be actually determined to be positive, and the larger a value of the ratio is, the higher the performance of the determiner is. The recall is expressed by (the number of samples of TP)/(the number of samples of TP+the number of samples of FN). The precision is a ratio of data that is actually positive among data that has been determined to be positive by the determiner, and the larger a value of the ratio is, the higher the performance of the determiner is. The precision is expressed by (the number of samples of TP)/(the number of samples of TP+the number of samples of FP).

In step S2, the possibility determination unit 42 may use a condition under which the recall or the precision of the registered unknown word possibilities increases using an unknown word to be registered in the dictionary data manually selected from at least one extracted unknown word 31 as a reference (correct data). Such a condition can be optimized by the recall or the precision being actually calculated using various conditions using past extraction records. Specifically, for example, although an extracted unknown word 31 having a higher number of appearances in each of the corpuses is a term that frequently appears in the corpuses, the extracted unknown word 31 is less important in use of FAQ retrieval, and if the extracted unknown word 31 is directly registered in the dictionary data, the performance of FAQ retrieval may be rather deteriorated. Therefore, in a specific application, a condition under which an extracted unknown word 31 having a higher number of appearances in each of the corpuses is not extracted as a registered unknown word possibility 32 may be used. Alternatively, a condition under which a corpus having a higher number of appearances in a certain corpus but having a lower number of appearances in another corpus is extracted among a plurality of the corpuses may be used.

In step S3, the possibility determination unit 42 (processor 11) generates a presentation screen for displaying and presenting the registered unknown word possibilities extracted in step S2 to a worker, and causes the display unit 16 to display the presentation screen. For example, the possibility determination unit 42 (processor 11) may generate a screen displaying a list of the registered unknown word possibilities extracted in step S2 as a presentation screen and cause the display unit 16 to display the screen. When the processing of step 3 is completed, the word selection support device 10 ends the processing of the flowchart.

As described above, the word selection support device 10 acquires at least one extracted unknown word 31 that is a term not registered in dictionary data and extracted from the target corpus 21 from the unknown word extraction device 30. The word selection support device 10 derives statistical information 35 regarding the appearances of an extracted unknown word 31 in a plurality of corpuses including the target corpus 21 (for example, number of appearances in each of the corpuses) for each of extracted unknown words 31. The word selection support device 10 calculates the appropriateness as a registered unknown word possibility 32 that is a possibility for an unknown word to be registered in the dictionary data from the at least one extracted unknown word 31 on the basis of the statistical information 35, and determines a registered unknown word possibility 32. As described above, the word selection support device 10 narrows down the extracted unknown word 31 acquired from the unknown word extraction device 30 on the basis of the statistical information 35 regarding the appearances of the extracted unknown word 31 in the plurality of corpuses. Therefore, according to the word selection support device 10, useful unknown words to be registered in a dictionary in an application target domain can be efficiently selected from a word group mechanically extracted as unknown words with the appearances in the plurality of corpuses including the target corpus 21 being reflected. Furthermore, since the word selection support device 10 generates a presentation screen of extracted registered unknown word possibilities and causes the display unit 16 to display the presentation screen, a worker can easily confirm the extracted registered unknown word possibilities.

Furthermore, the word selection support device 10 determines registered unknown word possibilities 32 on the basis of the statistical information 35 regarding the appearances of the extracted unknown words 31 in the plurality of corpuses including at least one of a general corpus 22 or a specialized corpus 23 in addition to the target corpus 21 of the extracted unknown words. Therefore, according to the word selection support device 10, unknown words having high necessity of dictionary registration can be effectively selected with information of, not only the target corpus 21, but also document data in a general field or document data in a specialized field related to the target corpus 21 being reflected.

Furthermore, the word selection support device 10 uses a condition under which the recall or the precision of past registered unknown word possibilities 32 increases using an unknown word to be registered in the dictionary data manually selected from at least one extracted unknown word 31 as a reference (correct data). Therefore, according to the word selection support device 10, appropriate terms can be registered in the dictionary data according to the use and the purpose.

Note that the word selection support device 10 may store the registered unknown word possibilities 32 decided in step S2 in the storage 14 or display the registered unknown word possibilities 32 on the display unit 16 after the processing in step 2 is completed.

As described above, the word selection support device 10 selects registered unknown word possibilities 32 on the basis of appearance frequency distributions of extracted unknown words in a plurality of corpuses (statistical information). In order to support the dictionary registration work, the word selection support device 10 of the present embodiment selects registered unknown word possibilities 32 from extracted unknown words 31 and presents the possibilities to a worker, thereby selecting possibilities in advance and improving the efficiency of the dictionary registration work. Here, this automatic selection is implemented by filtering being performed by not only a corpus of an extraction source that is a work target but also a corpus including general terms and a corpus including technical terms being utilized, and by using the appearance frequencies of extracted unknown words in each of the corpuses.

### Second Embodiment

A word selection support device 10 according to the present embodiment excludes predetermined words such as words that are not established as words from extracted unknown words 31 output by an unknown word extraction device 30, and selects registered unknown word possibilities 32 from remaining extracted unknown words 36. Therefore, according to the word selection support device 10 according to the present embodiment, terms that should not be registered in dictionary data can be prevented from being mixed in registered unknown word possibilities 32, and thus the trouble of excluding the terms can be prevented. Hereinafter, configurations common to those of the first embodiment are denoted by the same reference signs, and detailed description thereof will be omitted.

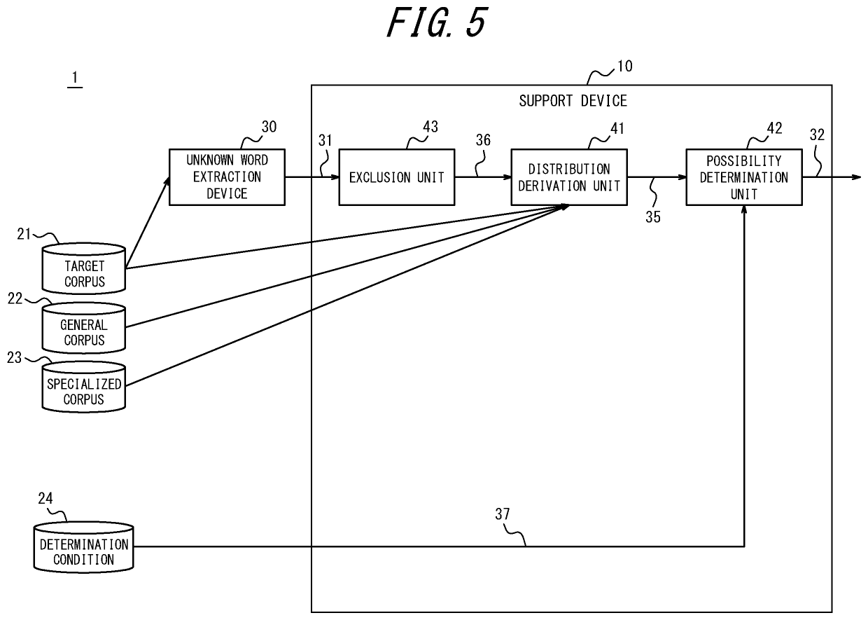

FIG. 5 is a block diagram illustrating a functional configuration example of a support system 1 using the word selection support device 10 according to one embodiment of the present disclosure. In FIG. 5, the word selection support device 10 includes an exclusion unit 43 in addition to a distribution derivation unit 41 and a possibility determination unit 42. The exclusion unit 43 excludes words that are not established as words from extracted unknown words 31 output by the unknown word extraction device 30, and outputs remaining extracted unknown words 36 to the distribution derivation unit 41. The distribution derivation unit 41 derives statistical information 35 regarding the appearances of an extracted unknown word 31 in a plurality of corpuses including a target corpus 21 for each of the extracted unknown words 36.

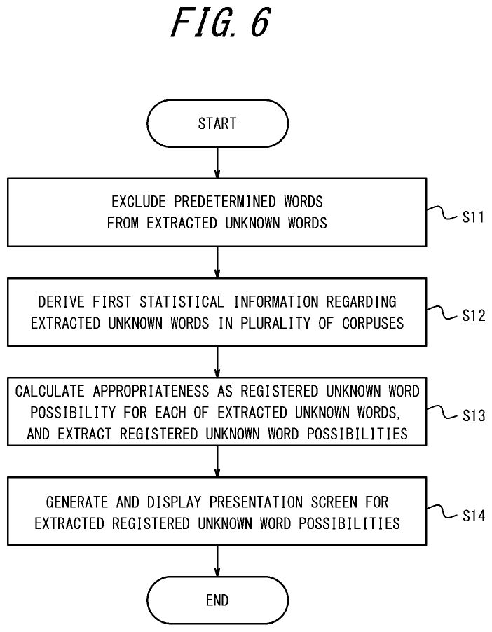

FIG. 6 is a flowchart illustrating an example of operation of the word selection support device 10 according to a second embodiment. The operation of the word selection support device 10 described with reference to FIG. 6 corresponds to a word selection support method according to the present embodiment. A program for causing a computer to execute the word selection support method according to the present embodiment includes steps illustrated in FIG. 6.

In step S11, the exclusion unit 43 (processor 11) receives extracted unknown words 31 as inputs, excludes predetermined words, and outputs the words as extracted unknown words 36 from which non-established words have been excluded. Here, the predetermined words may be, for example, words that are not established as words. The words that are not established as words are words of one character, words of only numbers, or the like. In addition, words starting with a number and words including a symbol may be included in the predetermined words to be excluded. Which word is to be excluded is set in advance as an exclusion rule.

Processing in steps S12 to S14 is similar to the processing in steps S1 to S3 in FIG. 4, and thus detailed description thereof will be omitted. When processing of step S14 is completed, the word selection support device 10 ends the processing of the flowchart.

As described above, the word selection support device 10 of the present embodiment excludes words that are not established as words from extracted unknown words 31 acquired from the unknown word extraction device 30, and derives statistical information 35 regarding the appearances of an extracted unknown word 36 in the plurality of corpuses for each of remaining extracted unknown words 36. The, the word selection support device 10 determines registered unknown word possibilities 32 that are possibilities for unknown words to be registered in dictionary data from at least one extracted unknown word 31 on the basis of the statistical information 35. As described above, the word selection support device 10 of the present embodiment selects registered unknown word possibilities 32 after excluding words that are not established as words in advance. Therefore, the word selection support device 10 of the present embodiment can prevent terms that should not be registered in dictionary data from being extracted and being mixed in registered unknown word possibilities 32, and can effectively select unknown words that are highly necessary to be registered in the dictionary.

Note that the word selection support device 10 may store registered unknown word possibilities 32 decided in step S13 in the storage 14 or display the registered unknown word possibilities 32 on a display unit 16 after processing in step 13 is completed.

As described above, the word selection support device 10 of the present embodiment excludes words that are not established as words in advance. The word selection support device 10 can narrow down words input to filtering processing of the subsequent stage to words having a higher possibility of being established as words by excluding words that are not established as words from words to be verified in advance, and can improve the performance of the filtering processing.

### Third Embodiment

A word selection support device 10 according to the present embodiment holds extracted unknown word records that are extracted unknown words used when unknown words are registered in a dictionary in the past, and registered unknown word records that are unknown words actually registered in the dictionary. The word selection support device 10 according to the present embodiment determines condition information 37 of a determination condition on the basis of statistical information in each corpus of such extracted unknown word records and registered unknown word records, and determines registered unknown word possibilities 32 on the basis of the condition information 37. Therefore, according to the present embodiment, the condition information 37 for which certain try and error is required can be automatically selected. Hereinafter, configurations common to those of the first embodiment and the second embodiment are denoted by the same reference signs, and detailed description thereof will be omitted.

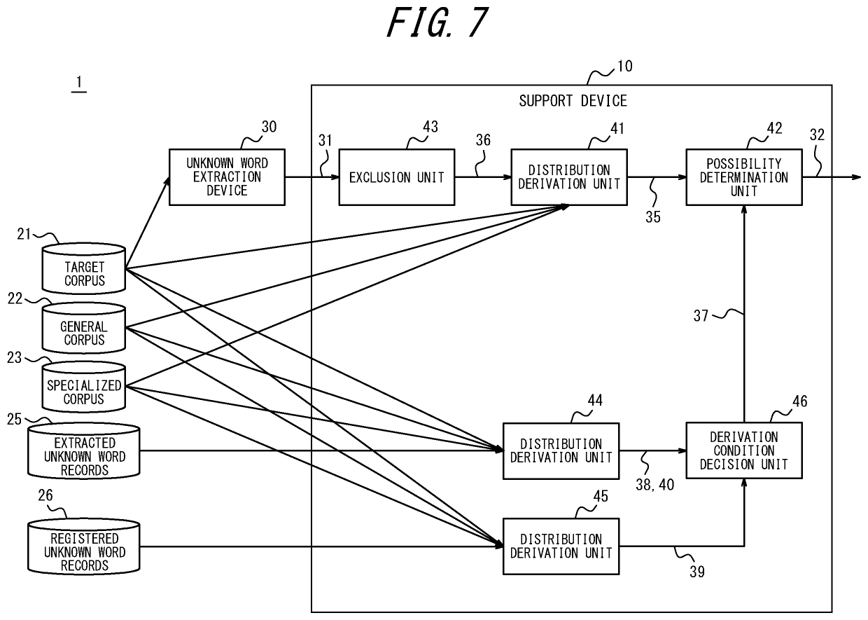

FIG. 7 is a block diagram illustrating a functional configuration example of a support system 1 using the word selection support device 10 according to one embodiment of the present disclosure. In FIG. 7, the support system 1 includes the word selection support device 10, a target corpus 21, a general corpus 22, a specialized corpus 23, extracted unknown word records 25, registered unknown word records 26, and an unknown word extraction device 30. The word selection support device 10 includes distribution derivation units 44 and 45 and a determination condition decision unit 46 in addition to a distribution derivation unit 41, a possibility determination unit 42, and an exclusion unit 43.

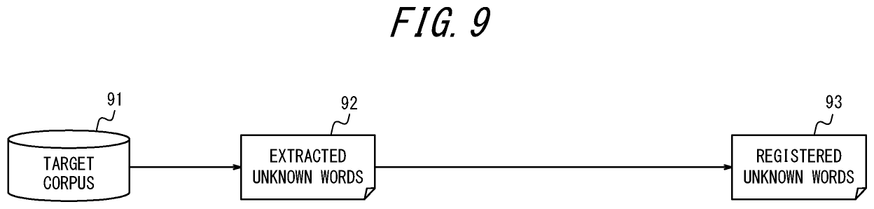

The extracted unknown word records 25 are extracted unknown words 31 referred to in selection of registered unknown words 33 performed in the past. The registered unknown word records 26 are terms that are selected as registered unknown word possibilities 32 from the extracted unknown words 31 referred to in the selection of registered unknown words 33 performed in the past, further selected as the registered unknown words 33 by a worker from such registered unknown word possibilities 32, and registered in dictionary data. Alternatively, the extracted unknown word records 25 may be extracted unknown words 92 referred to in selection of registered unknown words 93 performed in the past in FIG. 9, and the registered unknown word records 26 may be the registered unknown words 93 selected from the extracted unknown words 92 by a conventional method. In the extracted unknown word records 25 and the registered unknown word records 26, predetermined words may be deleted in advance according to an exclusion rule similar to that of the exclusion unit 43. As such predetermined words, for example, words that are not established as words may be deleted. The extracted unknown word records 25 and the registered unknown word records 26 are used for search for a determination condition for extracting registered unknown word possibilities 32 from extracted unknown words 31 (for example, parameter such as a threshold). Therefore, by predetermined words being deleted from the extracted unknown word records and the registered unknown word records according to the exclusion rule similar to that of the exclusion unit 43, a more appropriate determination condition can be obtained, and the performance of filtering by the possibility determination unit 42 can be further improved.

The distribution derivation unit 44 derives statistical information 38 regarding the appearances for each of the extracted unknown word records 25 in each corpus using the extracted unknown word records 25, the target corpus 21, the general corpus 22, and the specialized corpus 23 as inputs. The distribution derivation unit 45 derives statistical information 39 regarding the appearances for each of the registered unknown word records 26 in each corpus using the registered unknown word records 26, the target corpus 21, the general corpus 22, and the specialized corpus 23 as inputs.

On the basis of the statistical information 38 and 39, the determination condition decision unit 46 decides a condition under which the possibility determination unit 42 selects registered unknown word possibilities 32 from extracted unknown words 36, and outputs condition information 37 indicating the condition to the possibility determination unit 42. Specifically, in a case where unknown words are extracted from the extracted unknown word records 25 according to a specific condition on the basis of the statistical information 38, the determination condition decision unit 46 acquires statistical information 40 regarding the appearances of an extracted unknown word in a plurality of corpuses 21 to 23 for each of the extracted unknown words. The determination condition decision unit 46 then decides, as a determination condition, a specific condition under which the similarity between the statistical information 40 and the statistical information 39 is high.

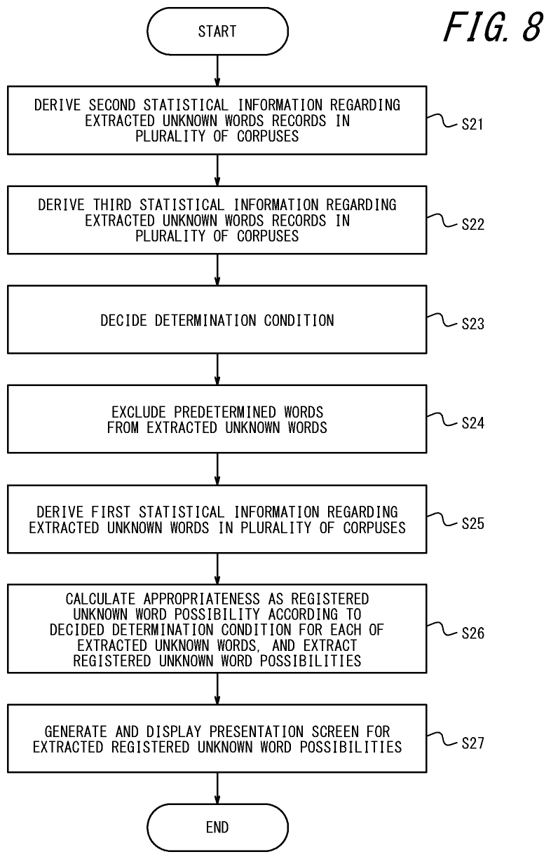

FIG. 8 is a flowchart illustrating an example of operation of the word selection support device 10 according to a third embodiment. The operation of the word selection support device 10 described with reference to FIG. 8 corresponds to a word selection support method according to the present embodiment. A program for causing a computer to execute the word selection support method according to the present embodiment includes steps illustrated in FIG. 8.

In step S21, the distribution derivation unit 44 (processor 11) derives statistical information 38 regarding the appearances in each of the corpuses for each of the extracted unknown words included in the extracted unknown word records 25 using the extracted unknown word records 25, the target corpus 21, the general corpus 22, and the specialized corpus 23 as inputs. Specifically, the distribution derivation unit 44 calculates the number of appearances in each of the corpuses for each of the extracted unknown words included in the extracted unknown word records 25, and outputs the frequency distribution and the number of the appearances of each of the extracted unknown words as statistical information 38.

In step S22, the distribution derivation unit 45 (processor 11) derives statistical information 39 regarding the appearances in each of the corpuses for each of the registered unknown words included in the registered unknown word records 26 using the registered unknown word records 26, the target corpus 21, the general corpus 22, and the specialized corpus 23 as inputs. Specifically, the distribution derivation unit 45 calculates the number of appearances in each of the corpuses for each of the registered unknown words included in the registered unknown word records 26, and outputs the frequency distribution and the number of the appearances of each of the registered unknown words as statistical information 39.

In step S23, the determination condition decision unit 46 (processor 11) decides a determination condition for selecting registered unknown word possibilities 32 from extracted unknown words 36 on the basis of the statistical information 38 derived in step S21 and the statistical information 39 derived in step S22. Specifically, the determination condition decision unit 46 decides, by performing search using any search method, a determination condition under which the statistical information 40 regarding the appearances of unknown words selected by giving a specific condition to each of the extracted unknown words of the extracted unknown word records 25 in each of the corpuses 21 to 23 is similar to the statistical information 39 regarding the appearances of the registered unknown word records 26 in each of the corpuses. The measure of the similarity may be defined as, for example, precision or recall for the registered unknown word records 26 of the unknown words selected by the specific condition being given to each of the extracted unknown words of the extracted unknown word records 25. Alternatively, the measure of the similarity may be defined by any evaluation method for the similarity between the statistical information 40 of the unknown words extracted from the extracted unknown word records 25 on the basis of the specific condition and the statistical information 39 of the registered unknown word records 26 for any unknown word. In this manner, the determination condition decision unit 46 searches for a determination condition under which the similarity between the statistical information 40 regarding the appearances of the unknown words extracted from the extracted unknown word records 25 in each of the corpuses 21 to 23 on the basis of the determination condition and the statistical information 39 regarding the appearances of the registered unknown word records 26 in each of the corpuses 21 to 23 is high, and decides the determination condition as a condition to be used. Specifically, the determination condition decision unit 46 may acquire a plurality of pieces of the statistical information 40 using a plurality of specific conditions, and use a specific condition having the highest similarity between the statistical information 40 and the statistical information 39 as the determination condition. Alternatively, the determination condition decision unit 46 may search for a specific condition under which the similarity between the statistical information 40 and the statistical information 39 evaluated by the similarity evaluation method exceeds a predetermined standard, and decides such specific condition as the determination condition.

Processing in steps S24 to S27 is similar to the processing in steps S11 to S14 in FIG. 3, and thus detailed description thereof will be omitted. However, in step S26, the possibility determination unit 42 decides registered unknown word possibilities 32 on the basis of the determination condition decided in step S23. When the processing of step 13 is completed, the word selection support device 10 ends the processing of the flowchart.

As described above, the word selection support device 10 of the present embodiment derives second statistical information 38 that is statistical information regarding the appearances of an extracted unknown word record 25 in a plurality of corpuses for each of the extracted unknown word records 25 that are extracted unknown words referred to in selection of unknown words to be registered in dictionary data performed in the past. The word selection support device 10 derives third statistical information 39 that is statistical information regarding the appearances of a registered unknown word record 26 in the plurality of corpuses for each of the registered unknown word records 26 that are unknown words registered in the dictionary data in selection of unknown words performed in the past. The word selection support device 10 determines a determination condition for determining registered unknown word possibilities 32 from at least one extracted unknown word 31 or 36 on the basis of the second statistical information 38 and the third statistical information 39. Specifically, in a case where unknown words are extracted from the extracted unknown word records 25 according to a specific condition on the basis of the second statistical information 38, the word selection support device 10 derives fourth statistical information 40 that is statistical information regarding an extracted unknown word in the plurality of corpuses 21 to 23 for each of the extracted unknown words. The word selection support device 10 decides, as a determination condition, a specific condition under which the similarity between the fourth statistical information 40 and the third statistical information 39 is high. Then, the word selection support device 10 determines registered unknown word possibilities 32 from at least one extracted unknown word 31 or 36 according to the decided determination condition. Therefore, according to the present embodiment, the condition information 37 for which certain try and error is required can be automatically selected.

Note that the word selection support device 10 may store registered unknown word possibilities 32 decided in step S26 in the storage 14 after processing in step S26 is completed.

As described above, the word selection support device 10 of the present embodiment decides a selection condition using past records. As described above, the word selection support device 10 performs filtering based on appearance frequency distributions in the plurality of corpuses using records of dictionary preparation performed in the past for the filtering condition. As a result, the filtering condition in the present invention in which certain try and error is required can be automatically set to some extent, and the use of the present technology is simplified.

According to each embodiment described above, possibilities of useful unknown words to be registered in a dictionary in an application target domain can be mechanically selected from a word group mechanically extracted as unknown words. As a result, as compared with a case where all words are confirmed manually, only the meaning and the usefulness as industry terms need to be manually determined, and thus more cases can be considered in the same time. Furthermore, according to each embodiment described above, since only words having a certain possibility of being useful are set as targets of work among words extracted as unknown words, a possibility of missing useful words can be reduced as compared with the conventional method in which the number of work targets is large.

The present disclosure is not limited to the embodiments described above. For example, a plurality of blocks in the block diagrams may be integrated, or one block may be divided. The plurality of steps in the flowchart may be executed in parallel or in a different order depending on throughput of a device that executes each step or as necessary, instead of being chronologically executed according to the description. Further, modifications can be made within the gist of the present disclosure.

With regard to the above embodiments, the following supplementary notes are further disclosed.

(Supplement 1)

A word selection support device including
a memory, and
at least one processor connected to the memory,
in which the processor derives,
for each extracted unknown word that is a term that is extracted from a target corpus and is not registered in dictionary data, first statistical information regarding the extracted unknown word in a plurality of corpuses including the target corpus, and
calculates appropriateness as a registered unknown word possibility that is a possibility of an unknown word to be registered in the dictionary data from the extracted unknown word on the basis of the first statistical information.

(Supplement 2)

A non-transitory storage medium that stores a program that can be executed by a computer, the non-transitory storage medium causing the computer to function as the word selection support device according to the supplement 1.

All documents, patent applications, and technical standards described in this specification are incorporated herein by reference to the same extent as if each individual document, patent application, and technical standard were specifically and individually described to be incorporated by reference.

### REFERENCE SIGNS LIST

1 Support system
10 Word selection support device
11 Processor
12 ROM
13 RAM
14 Storage
15 Input unit
16 Display unit
17 Communication I/F
19 Bus
21 Target corpus
22 General corpus
23 Specialized corpus
24 Determination condition
25 Extracted unknown word records
26 Registered unknown word records
30 Unknown word extraction device
31 Extracted unknown word
32 Registered unknown word possibility
35 Statistical information
36 Extracted unknown word
37 Determination information
38 Statistical information
39 Statistical information
41 Distribution derivation unit
42 Possibility determination unit
43 Exclusion unit
44 Distribution derivation unit
45 Distribution derivation unit
46 Determination condition decision unit

1. A word selection support device comprising processing circuitry configured to:
derive, for each extracted unknown word that is a term that is extracted from a target corpus and is not registered in dictionary data, first statistical information that is statistical information regarding the extracted unknown word in a plurality of corpuses including the target corpus; and
calculate appropriateness as a registered unknown word possibility that is a possibility of an unknown word to be registered in the dictionary data for each of the extracted unknown word on a basis of the first statistical information.

2. A word selection support device comprising processing circuitry configured to:
derive, for each extracted unknown word that is a term that is extracted from a target corpus and is not registered in dictionary data, first statistical information that is statistical information regarding the extracted unknown word in a plurality of corpuses including the target corpus; and
generate a presentation screen of a registered unknown word possibility that is a possibility of an unknown word to be registered in the dictionary data from the extracted unknown word on a basis of the first statistical information.

3. The word selection support device according to claim wherein the processing circuitry is configured to:
exclude a predetermined word from the extracted unknown word; and
derive the first statistical information regarding the extracted unknown word in the plurality of corpuses for each word obtained by excluding the predetermined word from the extracted unknown word.

4. The word selection support device according to claim 1, wherein the plurality of corpuses includes, in addition to the target corpus, at least one of a general corpus that is a corpus including document data in a general field or a specialized corpus that is a corpus including document data in a specialized field related to the target corpus.

5. The word selection support device according to claim 1, wherein the processing circuitry is configured to:
derive, for each extracted unknown word record that is the extracted unknown word referred to in selection of an unknown word to be registered in the dictionary data performed in a past, second statistical information that is statistical information regarding the extracted unknown word record in the plurality of corpuses;
derive, for each registered unknown word record that is an unknown word registered in the dictionary data in selection of an unknown word performed in the past, third statistical information that is statistical information regarding the registered unknown word record in the plurality of corpuses;
in a case where an unknown word is extracted from the extracted unknown word record under a specific condition on a basis of the second statistical information, decide, for each of the unknown word that is extracted, the specific condition under which similarity between fourth statistical information that is statistical information regarding the extracted unknown word in the plurality of corpuses and the third statistical information is high as a determination condition for determining the registered unknown word possibility from the extracted unknown word; and
determine the registered unknown word possibility from the extracted unknown word according to the decided determination condition.

6. The word selection support device according to claim 1, wherein the processing circuitry is configured to determine the registered unknown word possibility on a basis of the first statistical information such that recall or precision of the registered unknown word possibility is high using an unknown word to be registered in the dictionary data manually selected from the extracted unknown word as a reference.

7. A word selection support method comprising:
deriving, for each extracted unknown word that is a term that is extracted from a target corpus and is not registered in dictionary data, statistical information regarding the extracted unknown word in a plurality of corpuses including the target corpus; and
calculating appropriateness as a registered unknown word possibility that is a possibility of an unknown word to be registered in the dictionary data from the extracted unknown word on a basis of the statistical information.

8. A non-transitory computer readable recording medium recording a program for causing a computer to function as the word selection support device according to claim 1.

9. The word selection support device according to claim 2, wherein the processing circuitry is configured to:
exclude a predetermined word from the extracted unknown word; and
derive the first statistical information regarding the extracted unknown word in the plurality of corpuses for each word obtained by excluding the predetermined word from the extracted unknown word.

10. The word selection support device according to claim 2, wherein the plurality of corpuses includes, in addition to the target corpus, at least one of a general corpus that is a corpus including document data in a general field or a specialized corpus that is a corpus including document data in a specialized field related to the target corpus.

11. The word selection support device according to claim 2, wherein the processing circuitry is configured to:
derive, for each extracted unknown word record that is the extracted unknown word referred to in selection of an unknown word to be registered in the dictionary data performed in a past, second statistical information that is statistical information regarding the extracted unknown word record in the plurality of corpuses;
derive, for each registered unknown word record that is an unknown word registered in the dictionary data in selection of an unknown word performed in the past, third statistical information that is statistical information regarding the registered unknown word record in the plurality of corpuses;
in a case where an unknown word is extracted from the extracted unknown word record under a specific condition on a basis of the second statistical information, decide, for each of the unknown word that is extracted, the specific condition under which similarity between fourth statistical information that is statistical information regarding the extracted unknown word in the plurality of corpuses and the third statistical information is high as a determination condition for determining the registered unknown word possibility from the extracted unknown word; and
determine the registered unknown word possibility from the extracted unknown word according to the decided determination condition.

12. The word selection support device according to claim 2, wherein the processing circuitry is configured to determine the registered unknown word possibility on a basis of the first statistical information such that recall or precision of the registered unknown word possibility is high using an unknown word to be registered in the dictionary data manually selected from the extracted unknown word as a reference.

13. A non-transitory computer readable recording medium recording a program for causing a computer to function as the word selection support device according to claim 2.
